(19) United States
(12) Patent Application Publication
(10) Pub. No.: US 2006/0113943 A1
(43) Pub. Date: Jun. 1, 2006

(54) Contact-detecting apparatus

(75) Inventors: Nobuhiro Yamauchi, Chiryu-shi (JP); Masayoshi Takeuchi, Kariya-shi (JP)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(73) Assignee: AISIN SEIKI KABUSHIKI KAISHA, Kariya-shi (JP)

(21) Appl. No.: 11/274,260

(22) Filed: Nov. 16, 2005

(30) Foreign Application Priority Data
Nov. 17, 2004 (JP) 2004-333790

(51) Int. Cl. H02H 7/08; E05C 1/06; G08B 21/00

(52) U.S. Cl. 318/445; 292/144; 340/686.1; 340/665

(57) ABSTRACT

A contact-detecting apparatus provided at an open-and close device for detecting a state of contact with trapping object to be detected includes a piezoelectric sensor member for detecting a state of contact of the open-and close device with the trapping object to be detected, a detection circuit for receiving an output from the piezoelectric sensor, and a protector provided at the open-and close device and including a supporting member for supporting the piezoelectric sensor member and a base member integrally formed with the supporting member for supporting and protecting the detection circuit. Rigidity of the supporting member is lower than rigidity of the base member.

### CROSS REFERENCE TO RELATED APPLICATIONS

This application is based on and claims priority under 35 U.S.C. § 119 to Japanese Patent Application 2004-333790, filed on Nov. 17, 2004, the entire content of which is incorporated herein by reference.

### FIELD OF THE INVENTION

The present invention generally relates to a contact-detecting apparatus. More particularly, the present invention pertains to a contact-detecting apparatus including a protector provided at an open-and close device. The protector includes a supporting member for supporting a sensor for detecting a state of contact with trapping object to be detected and a base member integrally formed with the supporting member.

### BACKGROUND

In a conventional contact-detecting apparatus, for example as described in JP2002-97842A, in order to detect an object trapped between an electric sunroof of a vehicle and a frame body with which the electric sunroof makes contact, are included a piezoelectric sensor that generates a predetermined electric output at a time of contact with the object, and a judging means for judging, on the basis of electric output from the piezoelectric sensor, whether or not an object has been trapped. In such an apparatus, in order to improve accuracy in detecting an object that has been trapped, the piezoelectric sensor and the judging means are attached to a side of the movable electric sunroof. Specifically, the piezoelectric sensor and the judging means are integrally accommodated in a rubber sealing member of the electric sunroof. The piezoelectric sensor and the judging means may be subjected to the same vibrational conditions, if vibrations are generated when the electric sunroof is in action, or when the vehicle is running. Accordingly, there is hardly any difference of vibrations affecting between the piezoelectric sensor and the judging means. Therefore, unnecessary external force to the piezoelectric sensor can be prevented. In consequence, generation of noise between the piezoelectric sensor and the judging means can be reduced and accuracy in the detection of objects that have been trapped may be increased.

In the conventional contact-detecting apparatus described above, the piezoelectric sensor and a detection circuit (judging means) can be operated under the same vibrational conditions. On the other hand, if the scale of vibration generated when the electric sunroof makes contact with an object is modest, the piezoelectric sensor and the detection circuit vibrate in an similar manner. As a result, cases may arise where a state of contact cannot be detected. Further, if contacting speed of an object to be trapped with the piezoelectric sensor is high, approximately the same degree of shock is transmitted to the detection circuit. Accordingly, there have been cases where the detection circuit has been damaged. In order to cope with this problem, there is a limitation to simplify the detection circuit and to reduce costs of the contact-detecting apparatus. There has been scope for improvement.

A need for a contact-detecting apparatus having an increased level of accuracy in detecting contact with an trapping object and having improvement in an economical efficiency. The present invention has been made in view of the above and provides such a contact-detecting apparatus.

### SUMMARY OF THE INVENTION

According to an aspect of the present invention, a contact-detecting apparatus, provided at an open-and close device, for detecting a state of contact with trapping object to be detected, includes a piezoelectric sensor member for detecting a state of contact with the trapping object to be detected, a detection circuit for receiving an output from the piezoelectric sensor, and a protector including a supporting member for supporting the piezoelectric sensor member and a base member integrally formed with the supporting member for supporting, and protecting the detection circuit. Rigidity of the supporting member is lower than rigidity of the base member.

### BRIEF DESCRIPTION OF THE DRAWINGS

The foregoing and additional features and characteristics of the present invention will become more apparent from the following detailed description considered with reference to the accompanying drawings, wherein:

FIG. 1 represents a perspective view illustrating a vehicle in which a contact-detecting apparatus according to an embodiment of the present invention is applied;

FIG. 2 represents a cross-sectional view illustrating the contact-detecting apparatus according to the embodiment of the present invention;

FIG. 3 represents a cross-sectional view illustrating the contact-detecting apparatus illustrated in FIG. 2 when external force is applied;

FIG. 4 represents a partial perspective view illustrating a configuration of the contact-detecting apparatus according to the embodiment of the present invention;

FIG. 5A and FIG. 5B represent schematic views illustrating configurations of a piezoelectric sensor;

FIG. 6 represents a cross-sectional view illustrating a contact-detecting apparatus according to an additional embodiment of the present invention; and

FIG. 7 represents a schematic view illustrating a contact-detecting apparatus including a supporting member having cutouts(rifts).

### DETAILED DESCRIPTION

An embodiment of the present invention will be explained with reference to drawing figures. A contact-detecting apparatus according to the embodiment of the present invention can be provided at an open-and-close object, for example, in a vehicle and applied as an trap-detecting apparatus for detecting a trapping object to be detected, which is trapped between an electric door panel of the vehicle and a door frame of the vehicle. The apparatus can be provided, not only for a door panel, but also for example, for a power window and for an electric hatch back door. Further, the apparatus can be applied to a portion, where the trapping object that has been trapped needs to be detected, of an automatic open-and-close apparatus having an open-and-close condition between a door portion and a frame portion, or between plural door portions, for example, an automatic door and an automatic revolving door of a building, or a door of a railway vehicle. Furthermore, the apparatus can be provided at any object if a state of contact with trapping object to be detected, even when the object is not an open-and-close apparatus. In the embodiment, a contact-detecting apparatus will be explained which is provided at an electric door panel of a vehicle as an trap-detecting apparatus.

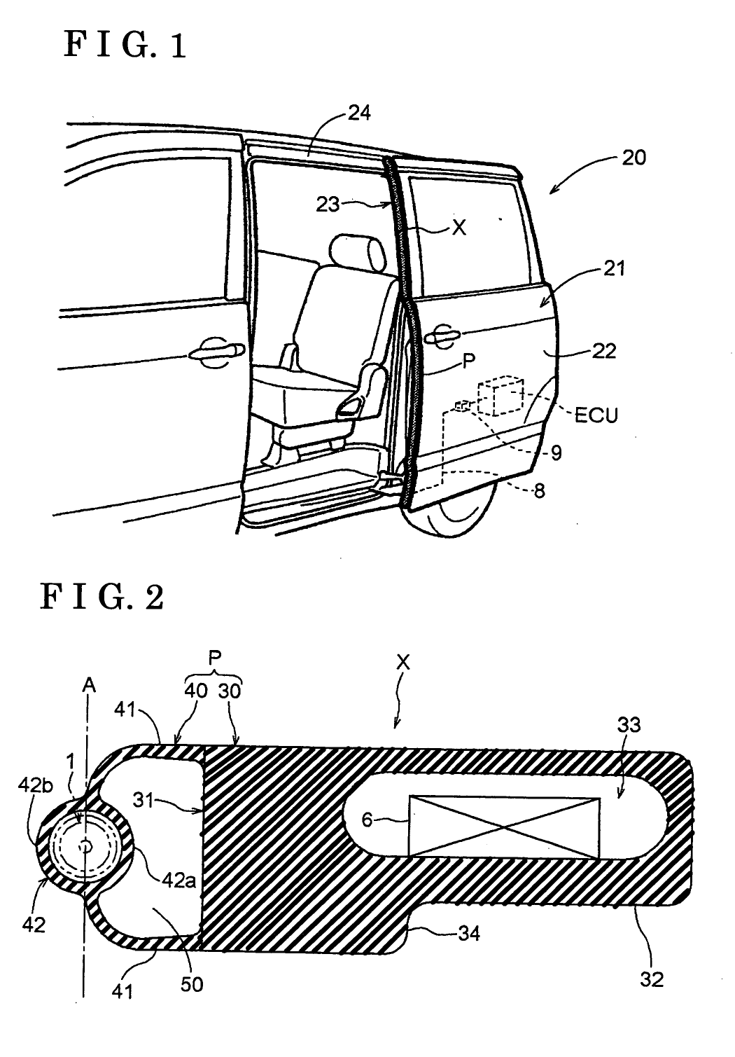

FIG. 1 represents a diagram illustrating a vehicle in which a contact-detecting apparatus X (trap-detecting apparatus) according to the embodiment of the present invention. The contact-detecting apparatus X is installed to a front end portion 23 of an electric door panel 22 serving as an open-and-close body 22 along an outline of the front end portion 23. The electric door panel 22 is installed over a rear entrance 24 of a vehicle 20.

FIGS. 2 to 4 represent schematic diagrams illustrating the contact-detecting apparatus X. In the contact-detecting apparatus X, a protector P including a supporting member 40 which can support a sensor which detects contact with an trapping object to be detected and a base member 30 integrally formed with the supporting member 40 is provided at the door panel 22 which automatically opens/closes. A piezoelectric sensor 1 and a detection circuit 6 are provided at an identical protector P. Accordingly, the piezoelectric sensor 1 and the detection circuit 6 are subjected to the same vibration conditions when the door panel 22 is automatically operated. Therefore, in comparison with a conventional contact-detecting apparatus in which a piezoelectric sensor is provided in a protector, and a detection circuit is provided in a door panel, in the contact-detecting apparatus X according to the embodiment of the present invention, vibrations on the basis of movement of the door panel 22 itself are difficult to detect as noises. Accordingly, a contact-detecting apparatus X of good accuracy can be performed. Individual component will now be explained below.

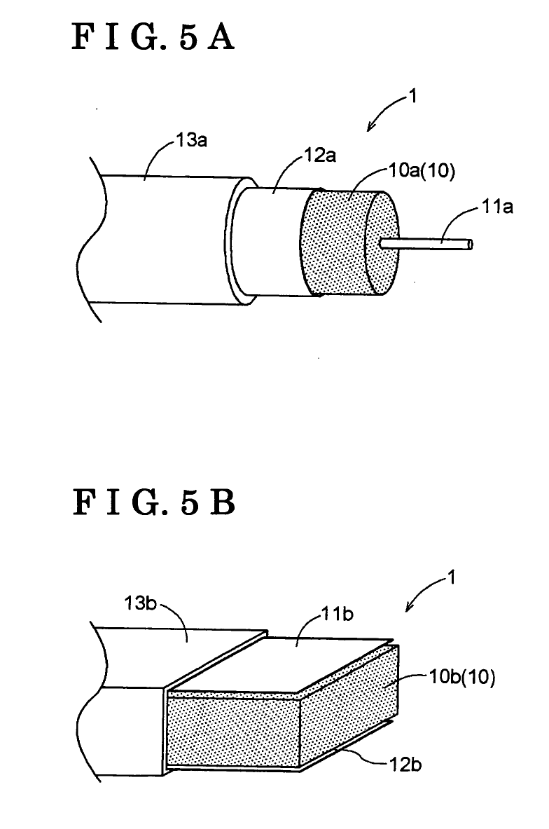

First, the piezoelectric sensor will be explained. FIGS. 5A and 5B represent schematic diagrams illustrating structure examples of the piezoelectric sensor 1. In FIG. 5A, the piezoelectric sensor 1 is structured as follows. A piezoelectric element 10a is sandwiched between a first electrode 11a (center electrode) in which an electric conductor is wound around a wire or a core and a second electrode 12a of a tubular shape (outer electrode). The piezoelectric element 10a, the first electrode 11a, and the second electrode 12a are concentrically provided and covered by an outer cover 13a and formed like a coaxial cable.

In FIG. 5B, the piezoelectric sensor 1 is structured as follows. A piezoelectric element 10b is sandwiched between a first electrode 11b of a planar shape and a second electrode 12b also of a planar shape. In view of simple installment of the piezoelectric sensor 1 to a position of a long shape such as a door and a door frame, the piezoelectric element 10b, the first electrode 11b, and the second electrode 12b are covered by an outer cover 13b and shaped like a planar cord.

As described above, when the piezoelectric sensor 1 is structured like a coaxial cable or a planar code, a long shape sensor can be easily installed. Such a long sensor can be flexibly provided along a curved door frame and/or a door of a vehicle or the like. Further, at the time of installment, a sensor of such a shape has the ability to react flexibly if it is bended, and/or if pressure is applied during installment. Thus, an trap-detecting apparatus can be preferably structured. As described above, two structure examples of the piezoelectric sensor are explained. However, a structure of the piezoelectric sensor is not limited to the structures described above. Any structure of a known piezoelectric sensor can be applied.

The piezoelectric element 10 is a sensor in which electric polarization on the basis of piezoelectric effect of substance is utilized. As the piezoelectric element 10, substance having piezoelectric effect, such as crystals of quartz, lead zirconate titanate, barium titanate can be applied. Such crystals generally show in addition to pyroelectricity. Pyroelectricity indicates a property of substance in which electric polarization is induced in a crystal when the temperature of the crystal is changed. When a substance selected from the substances described above is applied to the piezoelectric element 10, the piezoelectric element 10 can be utilized as a sensor which can detect an object on the basis of deflection of the piezoelectric element 10 itself deflected by stress induced by contact with an object.

Further, the first electrode 11 and the second electrode 12 can be made of any electrical conductive material such as gold and copper. Further, the outer cover 13 is shaped long and tubular and has insulation and elasticity. The outer cover 13 can be made of a synthetic resin, a rubber material, elastomer compound or the like.

Next, the supporting member will be explained. The supporting member 40 is a member for attaching the piezoelectric sensor 1 to the base member 30. Rigidity of the supporting member 40 is lower than rigidity of the base member 30 and has a member that, as seen from a longitudinal direction of the piezoelectric sensor 1, has a curved cross-sectional surface.

The supporting member 40 can support the piezoelectric sensor 1 by one leg or more legs of the supporting member 40. In the embodiment of the present invention, as illustrated in FIGS. 2 to 4, the piezoelectric sensor 1 is supported by a pair of leg portions 41. In the latter case, because the piezoelectric sensor 1 can be supported at both side surfaces of the piezoelectric sensor 1, in comparison with the case where the piezoelectric sensor is supported by one leg portion of the supporting member 40, the piezoelectric sensor 1 can be supported stably. Accordingly, an excessive deflection in a lateral direction of the piezoelectric sensor 1 can be inhibited. In addition, the supporting member 40 can be integrally formed with the base member 30. Alternatively, the supporting member 40 and the base member 30 can be formed as separate members. When the supporting member 40 and the base member 30 are formed as separate members, the supporting member 40 can be adhered on a connecting surface 31 of the base member 30. Further, the supporting member 40 can be a solid configuration not including spaces on a cross-section and plural leg portions. In other words, any structure can be applied as long as the supporting member 40 has a rigidity lower than that of the base member 30.

In addition, the supporting member 40 includes a cylindrical portion 42 connected to the leg portions 41. The piezoelectric sensor 1 can be inserted into the cylindrical portion 42. The cylindrical portion 42 is made of a rubber material, but it is not limited. Alternatively, the cylindrical portion 42 can be made of a synthetic resin material. The cylindrical portion 42 has long and tubular shape. The piezoelectric sensor 1 is inserted into the cylindrical portion 42.

As described above, rigidity of the supporting member 40 is lower than rigidity of the base member 30. Accordingly, when external force is applied to the contact-detecting apparatus X, the supporting member 40 can be more easily deformed than the base member 30. In this case, the supporting member 40 and the base member 30 can be made of either an identical material or different materials. Incidentally, it may be economically advantageous that the supporting member 40 and the base member 30 are made of an identical material.

Further, the supporting member 40 has members each having, as seen from a longitudinal direction of the piezoelectric sensor 1, a curved cross-sectional surface. In the embodiment of the present invention, the leg portions 41 are indicated as an example of the curved members. Such curved members applied can be easily deformed when external force is applied from every direction. As described above, because the supporting member 40 of the contact-detecting apparatus X is structured so that the supporting member 40 can be easily deformed, the piezoelectric sensor 1 can be easily deflected in accompany with the deformation of the supporting member 40. Accordingly, contact with an trapping object can be early recognized. Thus, the contact-detecting apparatus X can have high level of accuracy in detection.

Further, because the curved portion is of a structure that can be easily deformed, the piezoelectric sensor 1 is to some extent able to move toward the base member 30. In consequence, the impact of a shock that accompanies an open-and-close action of the door panel 22 can be mitigated. Further, even if the door panel 22 has continued moving in the closing action, according to the law of inertia, after the piezoelectric sensor 1 has detected an trapping object, it becomes possible to provide the time required for performing trap prevention control while the piezoelectric sensor 1 is to some extent moving toward the base member 30. In other words, before a pressing counter force is applied to an trapping object from the base member 30 that has been set to a high degree of rigidity, the trap prevention action can be completed. Accordingly, it is possible to prevent in advance any damage being caused to an trapping object through being trapped between the door panel 22 and the contact-detecting apparatus X. Further, although, there is normally a time lag between the time that the piezoelectric sensor 1 detects an trapping object and the time that an open-and-close operation of the door panel 22 can be commenced as an trap prevention control, it becomes possible to provide time for performing trap prevention action while the piezoelectric sensor 1 is to some extent moving toward the base member 30, and it is thus possible to nullify disadvantages caused by the time lag.

Here, if the supporting member 40 is for example a planer shape that does not have a curved cross-sectional structure, depending on the angles of external force that is generated when the object is trapped between the door panel 22 and the contact-detecting apparatus X and applied to the supporting member 40, the supporting member 40 resists the external force. In this case, the supporting member 40 cannot be easily deformed and a sufficient degree of deflection of the piezoelectric sensor 1 cannot be obtained.

Further, although not illustrated in drawings, an intermediate member of low rigidity can be provided in a first space 50 provided between the base member 30 and the pair of leg portions 41. More specifically, the intermediate member is provided in the first space 50 between the cylindrical portion 42 in which the piezoelectric sensor 1 is inserted, the pair of leg portions 41, and the base member 30. The intermediate member can be any of solid, liquid, and gas. For example, when the base member 30 is made of a hard rubber, a soft rubber or the like can be utilized as the intermediate member. Alternatively, water, oil, or the like, can be filled in the first space 50. Further, alternatively, foam, such as polyurethane foam or expanded polystyrene (EPS), can be disposed in the first space 50.

When the supporting member 40 is structured as described above, an apparent rigidity of the supporting member 40 can be controlled. As a result, even when deflection property of the piezoelectric sensor 1 is different depending on a piezoelectric sensor 1 utilized, an apparent degree of rigidity of the supporting member 40 can be controlled so that the supporting member 40 installed in the apparatus can exert appropriate deflection property. Further, even when mass and/or inertia at a time of contact of the trapping object in contact with the piezoelectric sensor 1 varies according to a position where the contact-detecting apparatus X is provided. The intermediate member provided can absorb shock given from contact with the object, and can appropriately control the degree of deflection of the piezoelectric sensor 1. Accordingly, in the contact-detecting apparatus X in which the intermediate member is disposed as described above, a sensitivity of the piezoelectric sensor 1 can be arbitrarily controlled. Further, the detection sensitivity and the detection accuracy of the contact-detecting apparatus X can be increased.

The leg portions 41 and the cylindrical portion 42 are connected as follows. When an outer peripheral surface of the cylindrical portion 42 is divided into two areas, a first area closer to the base member 30, and a second area less close to the base member 30, a position for attaching the pair of leg portions 41 to the cylindrical portion 42 is provided on the first area of the outer peripheral surface that is closer to the base member 30.

As illustrated in FIG. 2, when the outer peripheral surface of the cylindrical portion 42 is divided into two areas, consider an imaginary plane A passing a core of the cylindrical portion 42. The outer peripheral surface is divided into a first outer peripheral surface 42a closer to the base member 30 and a second outer peripheral surface 42b by the imaginary plane A. Then, when the pair of leg portions 41 is connected to the cylindrical portion 42, each leg portion is attached to the first outer peripheral surface 42a closer to the base member 30. When the leg portions 41 and the cylindrical portion 42 are structured as described above, because the cylindrical portion 42 is exposed to outside at a large ratio and the cylindrical portion 42 more easily contacts with an trapping object coming from outside, the piezoelectric sensor 1 can more easily detect external force from the trapping object through the cylindrical portion 42. Accordingly, contact with an trapping object can be detected with reliability.

Next, the base member will be explained. The base member 30 is structured so that the supporting member 40 in which the piezoelectric sensor 1 is inserted is attached to a connecting surface 31 provided at one end of the base member 30 and that an attaching end portion 32 provided at the other end of the base member 30 is attached to the front end portion 23 of the door panel 22. Thus, the piezoelectric sensor 1 can be installed to the front end portion 23 of the door panel 22. The base member 30 can be fitted into or engaged with the door panel 22.

Further, the contact-detecting apparatus X is structured to have a long shape. Accordingly, in order to install the entire contact-detecting apparatus X uniformly to the front end portion 23 of the door panel 22, the contact-detecting apparatus X includes an engaging portion 34 which engages with the front end portion 23 of the door panel 22. Accordingly, conditions such as an attaching depth can be made uniform for over the contact-detecting apparatus X, and a state can be inhibited where the contact-detecting apparatus X is excessively pressed into the door panel 22.

The base member 30 is made of a resin material such as a hard rubber of high rigidity in order to install firmly the contact-detecting apparatus X to the door panel 22. In this case, if a second space 33 is provided in the base member 30, in the solidification process of the base member 30 in manufacturing, the degree of unevenness of solidification temperature over the base member 30 can be reduced, and solidification of the base member 30 may be uniformed.

Next, the detection circuit will be explained. In the contact-detecting apparatus X, as illustrated in FIGS. 2 to 4, the detection circuit 6, which receives outputs from the piezoelectric sensor 1, is installed in the base member 30. In other words, because the piezoelectric sensor 1 is supported by the supporting member 40 of low rigidity and the detection circuit 6 is installed in the base member 30 of high rigidity, when the door panel 22 contacts with an trapping object, a portion of the piezoelectric sensor 1 contacting with the trapping object can mainly be deflected. Accordingly, the detection sensitivity of the contact-detecting apparatus X can become preferable.

Further, if the detection circuit 6 is provided at the base member 30 of high rigidity, when the door panel 22 and an trapping object contact with each other at a relatively high speed, a shock of contact can be absorbed at first by the supporting member 40 of low rigidity. Then, the energy of contact is decreased and transmitted to the base member 30 of high rigidity. However, it is difficult for the base member 30 to be deformed to a great extent because of high rigidity. Accordingly, damage to the detection circuit 6 caused by the bending force applied, or the like, can be inhibited. As described above, because it becomes difficult for contact with an trapping object to influence the detection circuit 6, a structure of the detection circuit 6 can be simplified. Accordingly, a contact-detecting apparatus X can be obtained that has economic advantages.

In addition, because the piezoelectric sensor 1 and the detection circuit 6 are installed to one protector P, the protector P portion can be in advance assembled before the door panel 22 is assembled. Further, the piezoelectric sensor 1 and the detection circuit 6 can be installed at once to the door panel 22. Thus, because making efficiency of the contact-detecting apparatus X can be improved, manufacturing costs of the contact-detecting apparatus X can be reduced.

As illustrated in FIGS. 2 to 4, in the embodiment, the detection circuit 6 is provided in the base member 30. Thus, providing the detection circuit 6 in the base member 30 enables that the detection circuit 6 itself is protected from contacting with an trapping object. Accordingly, a structure of the detection circuit 6 can further be simplified. Further, providing the detection circuit 6 in the base member 30 can yield the contact-detecting apparatus X having good design.

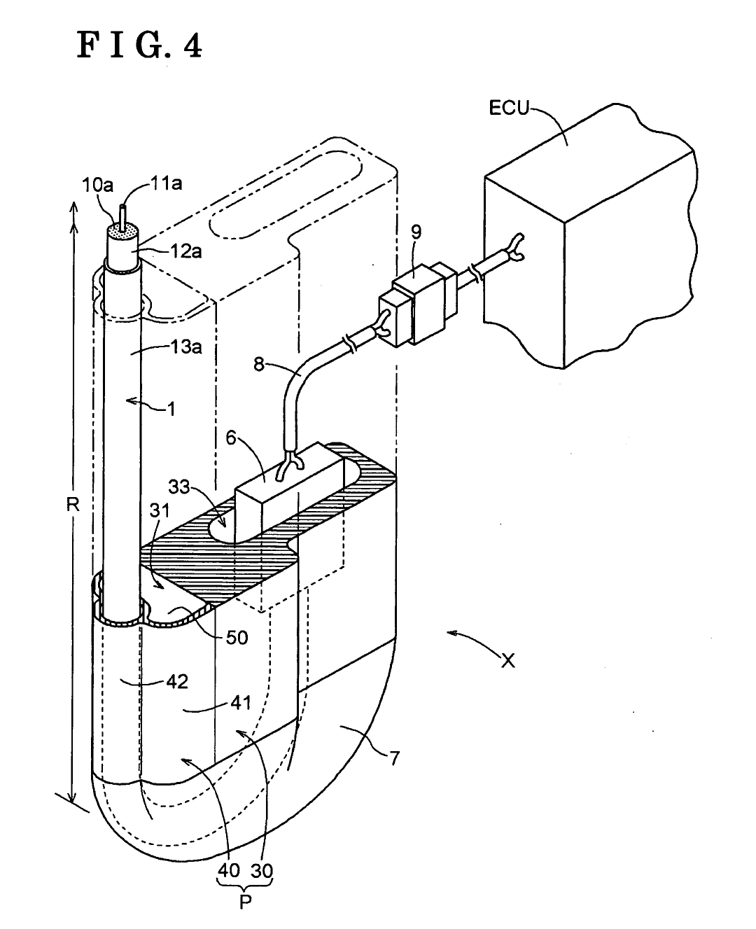

As illustrated in FIG. 4, the supporting member 40 is provided along the front end portion 23 of the door panel 22 so that a lower end portion of the supporting member 40 corresponds to a lower end of the door panel 22. The piezoelectric sensor 1 reaches an end portion of the supporting member 40 and protrudes downward. An end portion of the piezoelectric sensor 1 protruding is introduced upward along an inner peripheral surface of a protector cap 7, which is an approximately half circle plate, provided at a lower end portion of the protector P. The piezoelectric sensor 1 protrudes upward into the second space 33 formed in the protector P.

In the embodiment, the detection circuit 6 is provided at a position right above the piezoelectric sensor 1 immediately inside the second space 33. The detection circuit 6 can be fixed to a wall portion of the second space 33 by means of adhesive, an adhesive tape, or the like. The end portion of the piezoelectric sensor 1 is directly connected to the detection circuit 6. If the piezoelectric sensor 1 and the detection circuit 6 are connected through a harness, depending on the standard of harnesses, noises are transmitted from the harness into the detection circuit 6. However, as described above, because the end portion of the piezoelectric sensor 1 is directly connected to the detection circuit 6, such generation of noise due to a harness can be inhibited. Accordingly, accuracy in detection of contact can be enhanced.

From the detection circuit 6, detection signals are transmitted through a harness 8 to a connector 9. A part of the harness 8 and the connector 9 are provided in the door panel 22. The connector is connected to an electronic control unit (ECU), which is provided in the door panel 22. The ECU performs detection of a contacting trapping object and controls action of the door panel 22.

The detection circuit 6 can be provided either one end portion of a contact-detecting area R in which the piezoelectric sensor 1 is provided. In FIG. 4, the detection circuit 6 is provided near a lower end portion of the contact-detecting area R. Alternatively, the detection circuit 6 can be provided near an upper end portion (in FIG. 1 or 4) of the contact-detecting area R also. Thus, by providing the detection circuit 6 near either one end of the contact-detecting area R of the piezoelectric sensor 1 of the contact-detecting area R, a transmission distance from the piezoelectric sensor 1 to the detection circuit 6 can be made short. Accordingly, transmission loss of the detection signals can be restricted. Further, by making the transmission distance short, possibility of generating unnecessary piezoelectric signals can be lowered. Further, because a length of the piezoelectric sensor 1 to the detection circuit 6 can be reduced, costs for making the contact-detecting apparatus X can be reduced.

Next, actions of the open-and-close body will be explained. Actions of the door panel 22 accompanying with the door being opened/closed will be explained taking a situation of a vehicle including the contact-detecting apparatus X structured as described above and provided at the door panel 22.

For opening the door, the door panel 22 fitted onto the entrance 24 and on the same plane as a side wall surface of the vehicle is shifted and displaced from the side wall surface of the vehicle. Then, the door panel 22 is moved to slide along the side wall of the vehicle rearward in respect to the vehicle 20. On the other hand, for closing the door, the door panel 22 is shifted and displaced from the side wall surface of the vehicle, is moved to slide along the side wall of the vehicle frontward in respect to the vehicle 20 and is fitted onto the entrance 24 so that the door panel 22 is placed on the same plane as the side wall surface of the vehicle. At this time, just before the door panel 22 is fitted onto the entrance 24, the door panel 22 moves toward the entrance 24 from an oblique direction. Accordingly, the door panel 22 comes into contact with the contact-detecting apparatus X from an oblique direction.

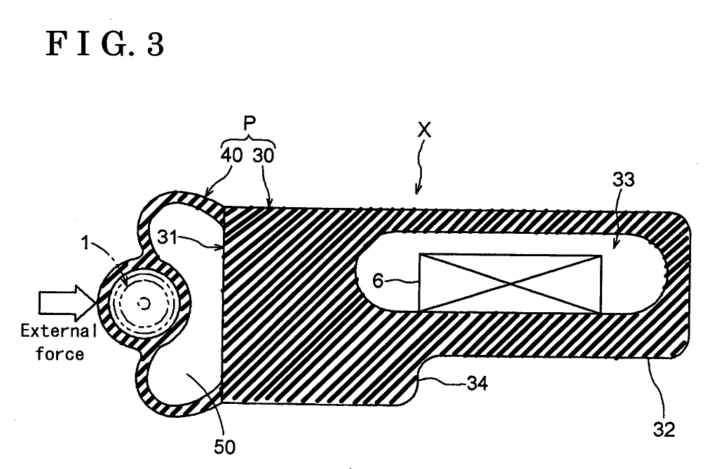

In the structure described above, rigidity of the supporting member 40 is lower than rigidity of the base member 30 and is structured of cross-sectional curved surface having a member, as seen from a longitudinal direction of the piezoelectric sensor 1. Accordingly, in a case where there is an trapping object between the entrance 24 and the door panel 22, even when the door panel 22 makes contact with the trapping object from an oblique direction, the curved portion can be easily deformed (as illustrated in FIG. 3). Accompanied with the deformation of the curved portion, the piezoelectric sensor 1 is deflected and the presence of the trapping object can be detected. In this case, as described above, it becomes difficult for an trapping object that has been trapped to be damaged.

In addition, the contact-detecting apparatus X outputs a signal according to piezoelectric effect from the piezoelectric sensor 1 subjected to external force on the basis of vibrations or shocks. Then, the contact-detecting apparatus X is connected to a control means for processing the signal outputted from the piezoelectric sensor 1 and performing control with respect to trap prevention. The trap prevention control includes, for example, controls for moving the door panel for opening the door and controls for stopping closing action of the door.

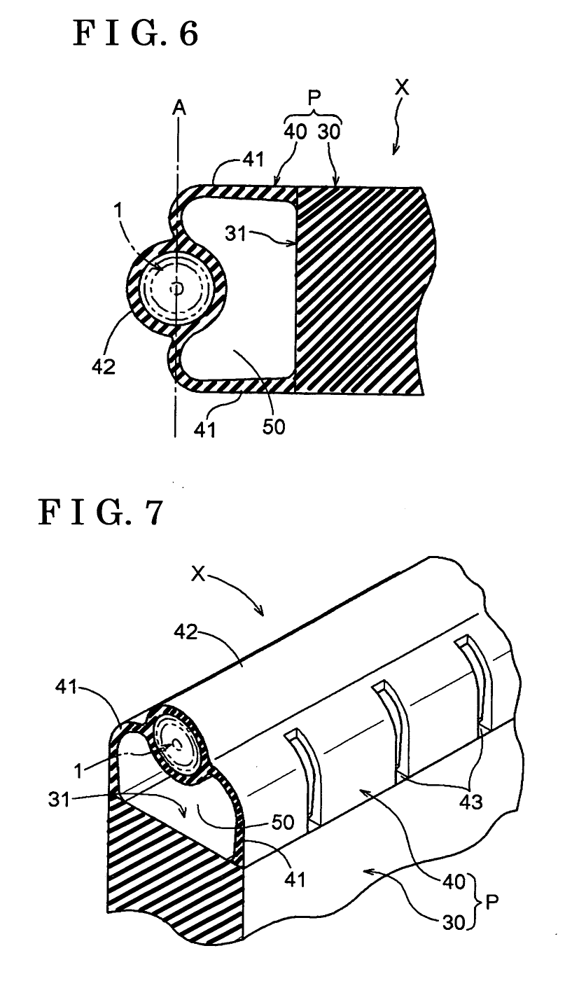

Next, a first additional embodiment will be explained. In the first additional embodiment, the leg portions 41 and the cylindrical portion 42 can be connected as follows. As illustrated in FIG. 6, the pair of leg portions 41 is connected to the cylindrical portion 42 at an oblique angle where the pair of leg portions 41 approaches the base member 30, as viewed on a cross section perpendicular to a core of the cylindrical portion 42. In other words, the supporting member 40 is configured to extend from the connecting surface 31, go over the plane A, extend toward the base member 30, and make contact with the cylindrical portion 42.

Configured as described above, when an trapping object makes contact with the cylindrical portion 42, the possibility of the direction in which the trapping object makes contact and the direction in which the leg portions 41 are connected becoming identical becomes small. Accordingly, it is difficult for the leg portions 41 to resist, and they are easily deflected. Thus, the supporting member 40 can be easily deformed as a result of external force, the degree of deflection of the piezoelectric sensor 1 can be sufficient, and accuracy in detecting an trapping object can be enhanced.

Next, a second additional embodiment will be explained. In the second additional embodiment, the supporting member 40 can include intermittent portions with a different degree of rigidity along a longitudinal direction of the supporting member 40. As the portions with a different degree of rigidity, for example, as illustrated in FIG. 7, plural cuts 43(rifts) can be provided along a longitudinal direction of the supporting member 40 and perpendicularly to the core of the cylindrical portion 42. Instead of the cuts 43, thin portion(s) can be provided. In this case, the cut portions 43, or the thin portion(s), have a degree of rigidity lower than other areas in the supporting member 40. In addition, as portions with a different degree of rigidity, that is portions with a degree of rigidity higher than other portions in the supporting member 40, can be provided. In this case, thick portion(s) can be provided along a longitudinal direction of the supporting member 40 and perpendicularly to the core of the cylindrical portion 42.

As described above, because portions of a different degree of rigidity are intermittently provided at the supporting member 40, the degree of deformation of an area sandwiched by the portions of a different degree of rigidity becomes different from those of other areas in the supporting member 40. At this time, the portions with a different degree of rigidity play a role of boundaries between adjacent areas of the supporting member 40. In other words, if portions with a different degree of rigidity are not provided, when an object makes contact with the cylindrical portion 42, the entire cylindrical portion 42 is deflected, and the entire piezoelectric sensor 1 also becomes deflected. In this case, there is a danger that sufficient output cannot be obtained from the piezoelectric sensor 1.

On the other hand, if the supporting member 40 is configured according to the second additional embodiment, because the supporting member 40 includes intermittently provided portions with a different degree of rigidity, it becomes difficult for contact with an object to be transmitted to an adjacent area in the cylindrical portion 42. Therefore, only areas sandwiched by portions with a different degree of rigidity, and the vicinity of portions sandwiched by portions with a different degree of rigidity, are deformed. Accordingly, areas sandwiched by portions with a different degree of rigidity deform to a greater degree than other areas of the supporting member 40. In consequence, the degree of deflection of the piezoelectric sensor 1 in areas sandwiched by portions with a different degree of rigidity can be large.

Accordingly, according to the second additional embodiment, contact with an object is detected not on the basis of deflection of the entire supporting member 40 but on the basis of deflection of localized portions of the supporting member 40. Therefore, accuracy of detection on the part of the piezoelectric sensor 1 can be improved and contact with an object can be detected with reliability.

Next, a third additional embodiment will be explained. In the embodiment of the present invention described above, an example was mentioned in which a pair of leg portions 41 was connected to the supporting member 40. However, it is not limited. For example, the supporting member 40 can be configured from a solid and wide member or the like, not including a space defined by a pair of leg portions. However, a rigidity of the supporting member 40 is set smaller than a rigidity of the base member 30. When such member is utilized, a sensitivity of the piezoelectric sensor 1 can be appropriately controlled and a reliable contact-detecting apparatus X can be obtained.

A contact-detecting apparatus X according to the embodiment of the present invention can be provided at an open-and-close object, for example, on a vehicle, and can be utilized as an trap-detecting apparatus for detecting trapping object to be detected between a door panel in an electric slide door of the vehicle and a door frame of the vehicle. The apparatus can be provided, not only for the electric slide door, but also for a power window and/or an electric hatch back door, or the like. In addition, the position for installing the apparatus is not limited to a vehicle, and the apparatus can also be installed on any portion, not limited to a vehicle, where an object that has been trapped needs to be detected, of an automatic open-and-close apparatus having an open-and-close condition between a door portion and a frame portion, or between plural door portions, for example, an automatic door and an automatic revolving door in buildings, or a door of a railway vehicle. Further, the apparatus can be provided at any object if a state of contact of the object with trapping object to be detected, even when the object is not an open-and-close apparatus.

According to a first aspect of the present invention, a contact-detecting apparatus provided at an object for detecting a state of contact of the object with trapping object to be detected includes a piezoelectric sensor member for detecting a state of contact of the object with the trapping object to be detected by deflection, a detection circuit for receiving an output from the piezoelectric sensor, and a protector provided at the object and including a supporting member for supporting the piezoelectric sensor member and a base member integrally formed with the supporting member for supporting and protecting the detection circuit. The supporting member has a rigidity lower than that of the base member.

According to the aspect of the present invention, because the piezoelectric sensor and the detection circuit are formed in the same protector, when the contact-detecting apparatus is provided at an open-and-close body, the piezoelectric sensor and the detection circuit are subjected to the same vibrational conditions at a time of automatic open-and-close action of the open-and-close body. Accordingly, in comparison with a conventional contact-detecting apparatus in which a piezoelectric sensor is provided in a protector, and a detection circuit is provided in an open-and-close body, it becomes difficult for vibrations to be detected as noises on the basis of movement of the open-and-close body itself. Thus, a contact-detecting apparatus of good accuracy can be obtained.

Then, according to the same aspect of the present invention, the piezoelectric sensor which can detect trapping object to be detected on the basis of deflection of the piezoelectric sensor is supported by the supporting member of a lower degree of rigidity, and the detection circuit is supported by the base member of a high degree of rigidity. Accordingly, in actual, during contact with the trapping object to be detected, deflection is induced mainly at a contacting portion of the piezoelectric sensor. Therefore, detection sensitivity can be preferable. Further, if the detection circuit is provided in the base member of a high degree of rigidity, when the open-and-close body and the trapping object to be detected strongly collide with each other, the shock of collision can be absorbed at first by the supporting member of a low degree of rigidity. After that, mitigated contact energy is transmitted to the base member of a high degree of rigidity. In this case, the base member is slightly deformed due to high rigidity. Thus, although some extent of shock is transmitted to the detection circuit, so large external force that can bend the detection circuit is not be applied. Accordingly, damage of the detection circuit can be inhibited. As described above, because it is difficult for contact with trapping object to be detected to influence the detection circuit, the structure of the detection circuit can be simplified. Accordingly, manufacturing cost for the contact-detecting apparatus can be lowered.

Further, according to the aspect of the present invention, because the piezoelectric sensor and the detection circuit are provided in one protector, before an assemble of the open-and-close body, an entire set of parts including the protector can be assembled in advance. Further, because the piezoelectric sensor and the detection circuit can be installed at once to the open-and-close body, making efficiency of the contact-detecting apparatus can be enhanced. In views described above, an economically superior contact-detecting apparatus can be obtained.

According to a second aspect of the present invention, an intermediate member is provided in a space defined by the supporting member and the base member and having a rigidity lower than that of the base member for adjusting the deflection amount of the sensor member.

According to the aspect of the present invention, the contact-detecting apparatus detects contact with trapping object to be detected on the basis of deflection of the piezoelectric sensor. In addition, detection sensitivity varies according to kind of piezoelectric sensors utilized. Accordingly, by utilizing cooperation with the supporting member for supporting the piezoelectric sensor, detection sensitivity of the contact-detecting apparatus needs to be appropriately controlled. Further, weight of trapping object in contact with the piezoelectric sensor and/or inertia of the trapping object at a time of contact vary according to a place where the contact-detecting apparatus is provided. Accordingly, the degree of deflection of the piezoelectric sensor when the piezoelectric sensor absorbs shock due to contact with trapping object to be detected need to be appropriately controlled.

Then, as according to the second aspect of the present invention, the supporting member includes the pair of leg portions, and an intermediate member is disposed in the space defined by the pair of leg portions and the base member. By so doing, an apparent degree of rigidity of the supporting member can be controlled. As a result, a level of sensitivity of the piezoelectric sensor can be arbitrarily controlled and levels of detection sensitivity and detection accuracy of the contact-detecting apparatus can be enhanced.

According to a third aspect of the present invention, the detection circuit is provided in the base member.

According to the third aspect of the present invention, the detection circuit is provided in the base member. By so doing, the detection circuit itself can be protected from contact with trapping object to be detected. Accordingly, a structure of the detection circuit can be simplified. Further, providing the detection circuit in the base member can yield well-designed contact-detecting apparatus.

According to a fourth aspect of the present invention, an end portion of the piezoelectric sensor member is directly connected to the detection circuit.

The detection circuit detects various noises due to vibrations of the vehicle and influence from electric field or the like. For example, inappropriate standard and/or wiring of connection wire between the piezoelectric sensor and the detection circuit causes generation of noise. In order to cope with this, as according to the fourth aspect of the present invention, an end portion of the piezoelectric sensor is directly connected to the detection circuit in order to reduce generation of noise as small as possible. Accordingly, accuracy in detecting a state of contact can be enhanced.

According to a fifth aspect of the present invention, the detection circuit is provided near a first end portion or a second end portion of a contact-detecting area where the piezoelectric sensor is provided.

According to the fifth aspect of the present invention, because the detection circuit is provided at near either one end of the contact-detecting area, a distance from the contact-detecting area to the detection circuit can be made short. As a result, a transmission distance between the piezoelectric sensor and the detection circuit can be made short. Accordingly, a transmission loss of detection signals can be restricted. Further, because the transmission distance is made short, possibility of generating unnecessary piezoelectric signal can be small. Further, because a length of a piezoelectric cable to the detection circuit can be made short, costs of the contact-detecting apparatus can be reduced.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. A contact-detecting apparatus provided a protector at an open-and close device comprising:
a piezoelectric sensor member for detecting a state of contact with a trapping object to be detected;
a detection circuit for receiving an output from the piezoelectric sensor; and
the protector provided a supporting member for supporting the piezoelectric sensor member and a base member integrally formed with the supporting member for supporting and protecting the detection circuit, and rigidity of the supporting member is lower than rigidity of the base member.

2. The contact-detecting apparatus according to claim 1, wherein
an intermediate member is provided in a space defined by the supporting member and the base member, and rigidity of the intermediate member is lower than rigidity of the base member.

3. The contact-detecting apparatus according to claim 1, wherein
the detection circuit is provided in the base member.

4. The contact-detecting apparatus according to claim 1, wherein
an end portion of the piezoelectric sensor member is directly connected to the detection circuit.

5. The contact-detecting apparatus according to claim 4, wherein
the detection circuit is provided near a first end portion or a second end portion of a contact-detecting area where the piezoelectric sensor is provided.

6. The contact-detecting apparatus according to claim 2, wherein
the detection circuit is provided in the base member.

7. The contact-detecting apparatus according to claim 2, wherein
an end portion of the piezoelectric sensor is directly connected to the detection circuit.

8. The contact-detecting apparatus according to claim 7, wherein
the detection circuit is provided near a first end portion or a second end portion of a contact-detecting area where the piezoelectric sensor is provided.

9. The contact-detecting apparatus according to claim 3, wherein
an end portion of the piezoelectric sensor is directly connected to the detection circuit.

10. The contact-detecting apparatus according to claim 7, wherein
the detection circuit is provided near a first end portion or a second end portion of a contact-detecting area where the piezoelectric sensor is provided.

11. The contact-detecting apparatus according to claim 9, wherein
the detection circuit is provided near a first end portion or a second end portion of a contact-detecting area where the piezoelectric sensor is provided.

12. The contact-detecting apparatus according to claim 1, wherein
the open-and close device at which the contact-detecting apparatus is provided is an automatic open-and-close body automatically opened/closed.

13. The contact-detecting apparatus according to claim 2, wherein
the open-and close device at which the contact-detecting apparatus is provided is an automatic open-and-close body automatically opened/closed.

14. The contact-detecting apparatus according to claim 4, wherein
the open-and close device at which the contact-detecting apparatus is provided is an automatic open-and-close body automatically opened/closed.

15. The contact-detecting apparatus according to claim 7, wherein
the open-and close device at which the contact-detecting apparatus is provided is an automatic open-and-close body automatically opened/closed.
